(19) United States
(12) Patent Application Publication
(10) Pub. No.: US 2012/0267058 A1
(43) Pub. Date: Oct. 25, 2012

(54) SYSTEM, METHOD AND APPARATUS FOR AREA SCREEN COVERAGE

(76) Inventor: Richard C. Smith, Homosassa, FL (US)

(21) Appl. No.: 13/542,688

(22) Filed: Jul. 6, 2012

Related U.S. Application Data
(63) Continuation of application No. 12/558,875, filed on Sep. 14, 2009, now Pat. No. 8,235,086.

(51) Int. Cl. E06B 9/08; E06B 9/24

(52) U.S. Cl. 160/121.1; 160/87; 160/405; 160/120

(57) ABSTRACT

An application for a multi-section screen system includes a first of the flexible sheets of screen material that has zipper teeth along at least one side edge and a neighboring second flexible sheet of screen material that has mating zipper teeth along an abutting side edge. Mechanisms retract and deploy each of the flexible sheets in unison. A fastener is fixedly disposed between each two of the mechanisms and the fastener automatically joins the zipper teeth with the mating zipper teeth as the mechanisms deploy the flexible sheets and the fastener automatically separates the zipper teeth from the mating zipper teeth as the mechanisms retract the flexible sheets.

### CROSS-REFERENCE TO RELATED PATENTS

This application is a continuation of co-pending application Ser. No. 12/558,875, titled “SYSTEM, METHOD AND APPARATUS FOR AREA SCREEN COVERAGE,” attorney docket number 843.4, filed Sep. 14, 2009, the disclosure of which is hereby included by reference.

### FIELD OF THE INVENTION

This invention relates to the field of screens and more particularly to a system for deploying screens.

### BACKGROUND

Deployable screen systems are well known in the industry. There are many reasons for using a deployable screen as opposed to fixed screens. For example, in areas where insects or other pests are present for only part of the day or for a season, screens are only needed during such time when the pest is present. Another example is in areas which are not used during certain periods. For example, a porch need not be screened during the winter months in Duluth, Minn., because it is too cold to use the porch during winter and, even if used, there would be no pests that need to be kept out.

Often, deployable screens include a flexible screen fabric that is stored on a roller (when not in use) and weighted along a bottom edge to allow deployment as the screen fabric is unrolled. In some cases, the left and right edges of the screen fabric are in a track to seal the screen over a certain area. Such systems function well for an area that is bounded by walls and of limited size, but for larger areas or areas not bounded by walls, such systems have performance problems.

For large areas such as wide garage doors, hanger doors and the like, the roller for storing such deployable screens of the prior art must be long enough as to contain the width of the screens. This results in very long rollers that need to be very rigid since a center support is not feasible due to the continuous width of the screen fabric. If the long rollers are not stiff enough, bowing results and the screen does not deploy evenly and bends and/or creases as it is retracted.

For areas that are not bounded by walls, it is very difficult to provide deployable screen solutions. For example, if there is a roof providing a top cover and three open sides areas, as often found in porch areas, but no corner structures, three separate deployable screens are required, one for each of the open sides. Because this porch area has no corner structures, there is no way to provide a side track for each of the screen fabrics when they are deployed. This leaves each of the two corners open after deployment, requiring some method of fastening to prevent unwanted pests/insects from entering at the corners. Before retraction, the fasteners require disengagement or the screen fabric will be damaged.

What is needed is a system for automatically deploying screens over a large area.

### SUMMARY OF THE INVENTION

In one embodiment, a multi-section screen system is disclosed including a first flexible sheet of fabric with a first set of zipper teeth disposed along a first side edge and a second flexible sheet of fabric with a mating set of zipper teeth disposed along a second side edge. The first side edge of the first flexible sheet of fabric is in proximity to the second side edge of second flexible sheet of fabric. A first mechanism is included for retracting and deploying the first flexible sheet of fabric and a second mechanism is included for retracting and deploying the second flexible sheet of fabric. A fastener is interfaced to the first set of zipper teeth and interfaced to the mating set of zipper teeth. The fastener joins the zipper teeth with the mating zipper teeth as the first mechanism deploys the first flexible sheet of fabric and the second mechanism deploys the second flexible sheet of fabric.

In another embodiment, a method of enclosing an area with multiple flexible sheets of material is disclosed using the multi-section screen system described above. The method includes operating the first mechanism for retracting and deploying in unison with the second mechanism for retracting and deploying to deploy the first flexible sheet of fabric and the second flexible sheet of fabric. As the first flexible sheet of fabric and the second flexible sheet of fabric deploy, the zipper teeth are automatically engaged with the mating zipper teeth by the fastener.

In another embodiment, a multi-section screen system is disclosed including a first flexible sheet that has zipper teeth disposed along a side edge, and a second flexible sheet that has mating zipper teeth disposed along a side edge. A first roller mechanism is interfaced to a first surface and a top edge of the first flexible sheet is interfaced to the first roller mechanism such that turning of the first roller mechanism in a first direction results in winding of the first flexible sheet around the first roller mechanism and turning of the first roller mechanism in an opposing second direction results in unwinding of the first flexible sheet from around the first roller mechanism. A second roller mechanism is interfaced to a second surface and a top edge of the second flexible sheet is interfaced to the second roller mechanism such that turning of the second roller mechanism in the first direction results in winding of the second flexible sheet around the second roller mechanism and turning of the second roller mechanism in the opposing second direction results in unwinding of the second flexible sheet from around the second roller mechanism. A fastener is slideably interfaced on one side to the zipper teeth and on a second side to mating zipper teeth so that the fastener automatically joins the zipper teeth with the mating zipper teeth as the first roller mechanism and the second roller mechanism turns in the first direction thereby deploying and joining the flexible sheets, and the fastener automatically disengages the zipper teeth from the mating zipper teeth as the first roller mechanism and the second roller mechanism turns in the second opposing direction, retracting and separating the flexible sheets.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a system of the present invention.

FIG. 2 illustrates a second perspective view of the present invention.

FIG. 3 illustrates a third perspective view of the present invention.

FIG. 4 illustrates a fourth perspective view of the present invention.

FIG. 5 illustrates a plan view of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

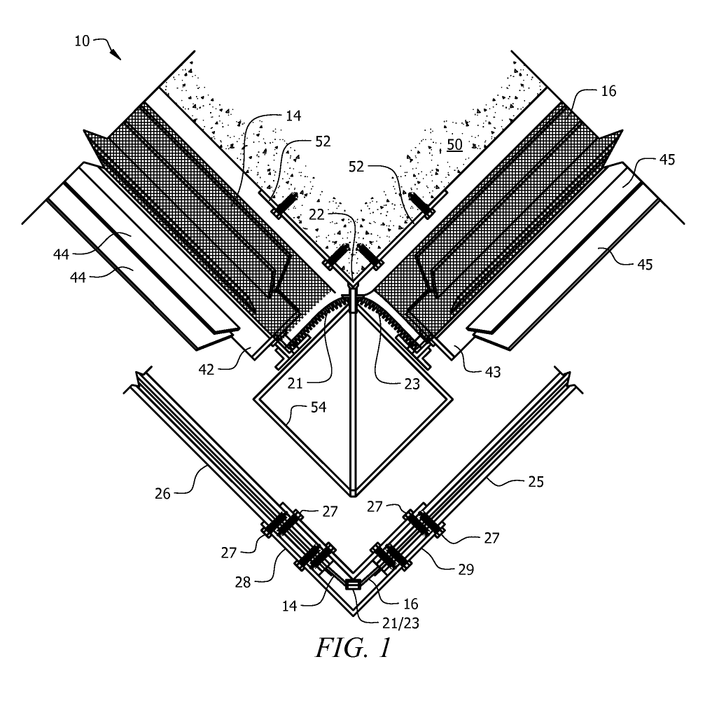

Referring to FIG. 1, a perspective view of a system of the present invention 10 is shown looking from the top. In this example, two screen fabrics 14/16 are deployable at an angle to each other, for example a 90 degree angle as shown. Although a 90 degree angle is shown, any desired angle between the screen fabrics 14/16 is anticipated. This example is similar to that encountered in a porch that is covered but lacks corner supports.

Although screen fabric 14/16 is shown in all examples, any flexible sheet of material is anticipated such as cloth, canvas, etc. It is also anticipated that in some embodiments, one or more of the flexible sheets of material has integrated features such as closable opening, windows (e.g. when the material is opaque), etc.

It is known to use a zipper mechanism to attach flexible sheets to each other. One example of such is canvas boat covers, in which multiple canvas, screen or clear plastic sheets are attached to each other using zippers and/or hook and loop material. In such, a person must position each pair of sheets, and then engage the zipper mechanism to connect one flexible sheet to the next.

In the present invention, a first flexible sheet 14 is automatically engaged with a second flexible sheet 16 as the sheets 14/16 are deployed and the a first flexible sheet 14 is disengaged from the second flexible sheet 16 as the flexible sheets 14/16 are retracted.

The exemplary system of FIG. 1 shows two flexible sheets of screen material 14/16. The first flexible sheet of screen material 14 has a first set of teeth 21 along a right edge and the second flexible sheet of screen material 16 has a mating set of teeth 23 along a left edge, such that, when deployed, the teeth 21/23 are in proximity of each other. As the flexible sheets of screen material 14/16 are deployed from the roller arrangements 42/43/44/45, the teeth 21/23 pass through a fastener 22 that locks the first set of teeth 21 into the mating set of teeth 23, thereby automatically affixing the first flexible sheet of screen material 14 to the second flexible sheet of screen material 16. The fastener 22 is fixed in a location between the first roller arrangement 42/44 and the second roller arrangement 43/45. Likewise, as the flexible sheets of screen material 14/16 are retracted, the teeth 21/23 pass through the fastener 22 in the opposite direction in which the first set of teeth 21 are automatically disengaged from the mating set of teeth 23, thereby allowing the first flexible sheet of screen material 14 to roll up on a first roller arrangement 42/44 and the second flexible sheet of screen material 16 to roll up on a second roller arrangement 43/45. Any form of roller arrangement 42/43/44/45 is anticipated. The example shown has a roller body 42/43 and fins 44/45. The fins 44/45 of such a roller arrangement 42/43/44/45, for example, strengthens the roller arrangement 42/43/44/45 to reduce bending, provides for cooling of the motor (not visible) by convection cooling and enables a flow of air beneath the flexible sheets of material 14/16 when the flexible sheets of material 14/15 are on the roller arrangement 42/43/44/45 to improve drying.

It is anticipated that the roller mechanism 42/43/44/45 is rotated to deploy and retract the flexible material 14/16 by any mechanism as known in the industry including, but not limited to, motors, hand cranks, etc. Such rotation mechanism is required to deploy and retract both flexible sheets of material 14/15 at the same rate (in unison) to prevent skewing. In the example of FIG. 1, the deploying/retracting mechanism is interfaced to the rollers 42/43 at the end that is not shown. In some embodiments, the motors are housed within the support bracket assembly 52/54. Although a single motor with a universal joint coupler adapted to drive two deploying/retracting mechanisms is preferred, separate motors, one for each deploying/retracting mechanism is anticipated as well.

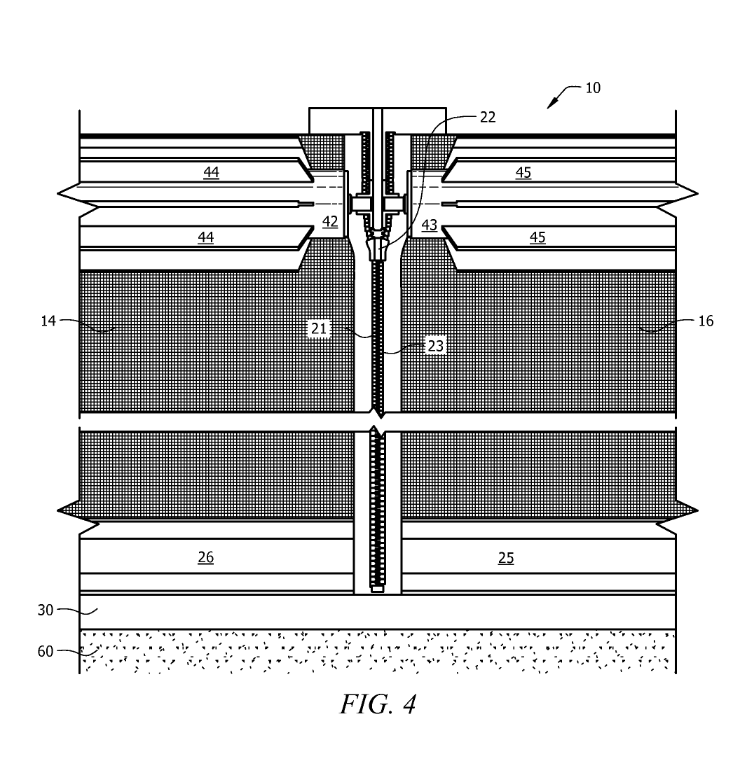

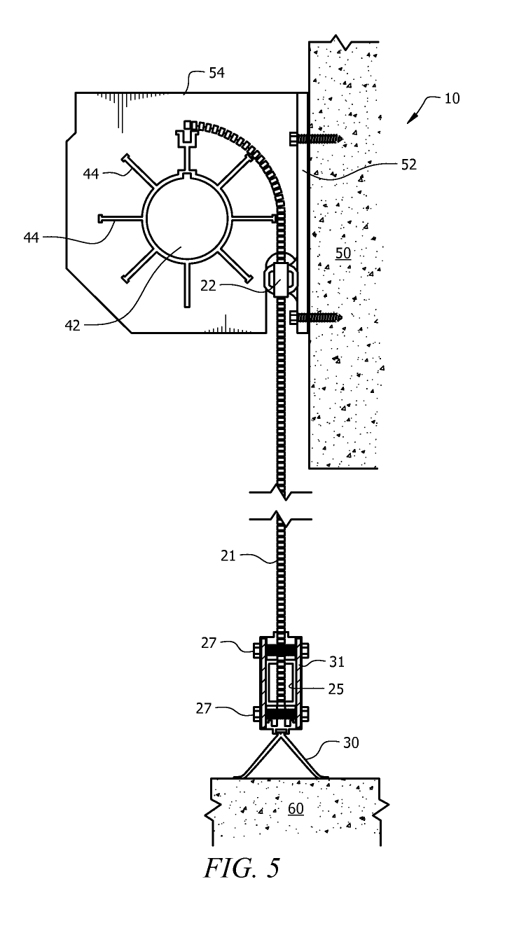

To help pull the flexible sheets of material 14/16 downward and keep each flexible sheet of material 14/16 taught, the bottom edge of the first flexible sheet of material 14 is connected to a bottom weight 26 and the bottom edge of the second flexible sheet of material 16 is connected to a bottom weight 25. In this example, the bottom weights 25/26 are linear metal frame members and are connected to each other with an 1-bracket 28/29 with screws 27. This is an example of bottom weights 25/26 and any known bottom weight arrangement is anticipated by the present invention. In some embodiments, multiple bottom weights 25/26 (one for each flexible sheet 14/16) are used (as shown in FIG. 4). In other embodiments, a continuous bottom weight 25/26 spans two or more flexible sheets 14/16 (as shown in FIGS. 1 and 5).

For completeness, brackets 52 of the support bracket assembly 52/54 are shown attached to a header 50 or other structural member of a building.

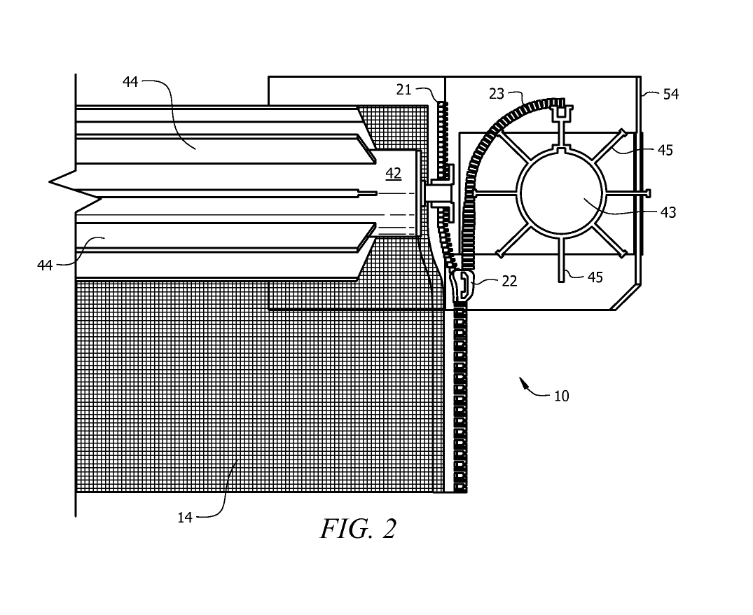

Referring to FIG. 2, a second perspective view of the present invention 10 is shown looking from the front of the first flexible sheet of screen material 14. In this view, the second flexible sheet of screen material 16 is not visible, but the mating set of teeth 23 along the left edge the second flexible sheet of screen material 16 is visible. In this view, the fastener 22 is grounded to the support bracket assembly 54 so that, as the roller mechanisms 42/43/44/45 deploy the flexible sheets of screen material 14/16, the teeth 21 along the right edge of the first flexible sheet of screen material 14 engage with the mating set of teeth 23 along the left edge the second flexible sheet of screen material 16. Likewise, as the roller mechanisms 42/43/44/45 retract the flexible sheets of screen material 14/16, the teeth 21 along the right edge of the first flexible sheet of screen material 14 disengage with the mating set of teeth 23 along the left edge the second flexible sheet of screen material 16.

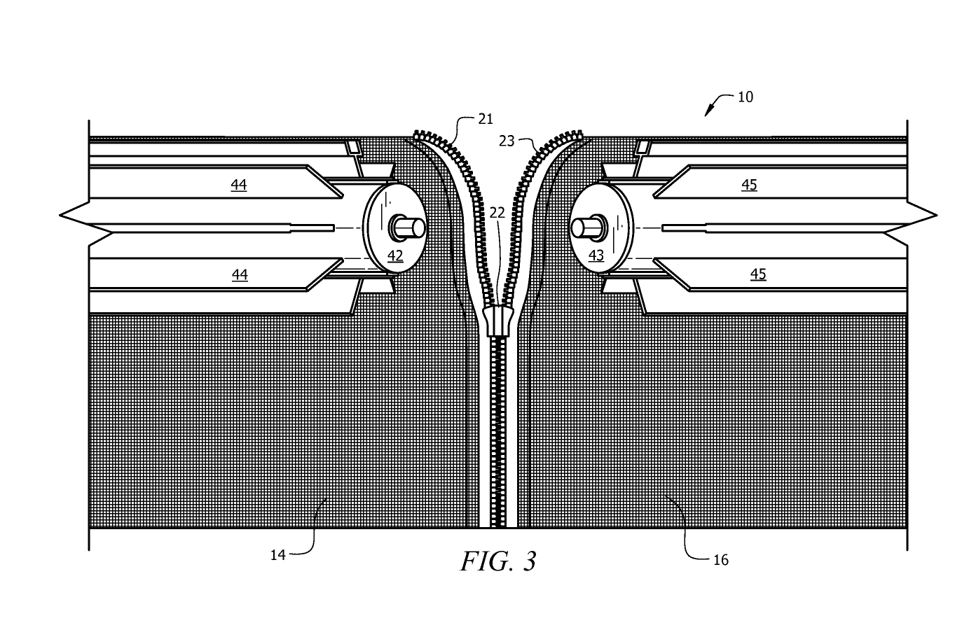

Referring to FIG. 3, a third perspective view of the present invention 10 is shown. In this example, the flexible sheets of screen material 14/16 are shown at an angle to each other, such as a 90 degree angle as shown in FIGS. 1 and 2.

Referring to FIG. 4, a fourth perspective view of the present invention 10 is shown. As in FIG. 3, in this example, the flexible sheets of screen material 14/16 are shown in a linear arrangement in which an axis passes through the first roller mechanism 42/44 and the second roller mechanism 43/45. In this, the flexible sheets of screen material 14/16 are shown fully deployed and the teeth 21 are locked with the mating teeth 23. The bottom weight sections 25/26 hold the flexible sheets of screen material 14/16 taught and enable deployment by pulling the flexible sheets of screen material 14/16 from the roller mechanism 42/43/44/45 as the roller mechanisms 42/43/44/45 turn in a direction of deployment. In some embodiments, a floor interface 30 is provided to improve sealing against uneven floors 60. In such, the floor interface 30 is made of a material that will conform to irregularities of the mating surface (floor) 60. As an example, the floor interface 30 is made of a flexible rubber. Other examples include, but are not limited to, bendable plastic, foam material, bristles, etc.

Referring to FIG. 5, a plan view of the present invention 10 is shown from the side. In this view, the flexible sheets of screen material 14/16 (not visible) are shown fully deployed and the teeth 21 are locked with the mating teeth 23 (not visible). The bottom weight sections 25/26 (only 25 is visible) are joined together by plates 31 held by screws 27 hold the flexible sheets of screen material 14/16 taught and enable deployment by pulling the flexible sheets of screen material 14/16 from the roller mechanism 42/43/44/45 as the roller mechanisms 42/43/44/45 turn in a direction of deployment. In some embodiments, a floor interface 30 is provided to improve sealing against uneven floors 60. In such, the floor interface 30 is made of a material that will conform to irregularities of the mating surface (floor) 60. As an example, the floor interface 30 is made of a flexible rubber. Other examples include, but are not limited to, bendable plastic, foam material, bristles, etc. In this example, the floor interface 30 is an inverted-V shape. As the flexible sheets of screen material 14/16 deploy completely, the inverted-V of the floor interface 30 is pushed against the floor 60 by the weight of the bottom weight sections 25/26, slightly deforming the inverted-V of the floor interface 30, providing an improved seal between the floor interface 30 and the floor 60.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A multi-section screen system comprising:
a first flexible sheet of fabric, a first set of zipper teeth disposed along a first side edge of the first flexible sheet of fabric;
a second flexible sheet of fabric, a mating set of zipper teeth disposed along a second side edge of the second flexible sheet of fabric, the first side edge of the first flexible sheet of fabric in proximity to the second side edge of second flexible sheet of fabric;
a first mechanism for retracting and deploying the first flexible sheet of fabric;
a second mechanism for retracting and deploying the second flexible sheet of fabric; and
a fastener interfaced to the first set of zipper teeth and interfaced to the mating set of zipper teeth, the fastener joining the zipper teeth with the mating zipper teeth as the first mechanism deploys the first flexible sheet of fabric and the second mechanism deploys the second flexible sheet of fabric.

2. The multi-section screen system of claim 1, further comprising a first weighted member disposed along a bottom edge of the first flexible sheet of fabric and a second weighted member disposed along a bottom edge of the second flexible sheet of fabric.

3. The multi-section screen system of claim 1, wherein the first mechanism for retracting and deploying includes a first roller mechanism and the second mechanism for retracting and deploying includes a second roller mechanism.

4. The multi-section screen system of claim 1, wherein the first flexible sheet of fabric is widthwise at an angle with respect to the second flexible sheet of fabric, wherein the angle is other than zero degrees and 180 degrees.

5. The multi-section screen system of claim 4, wherein the angle is 90 degrees.

6. The multi-section screen system of claim 1, wherein the first mechanism for retracting and deploying the first flexible sheet of fabric is affixed to a first support surface and the second mechanism for retracting and deploying the second flexible sheet of fabric is affixed to a second support surface and the fastener is held is a substantially static position between the first support surface and the second support surface.

7. A method of enclosing an area with multiple flexible sheets of material, the method comprising:
providing the multi-section screen system of claim 1; and
operating the first mechanism for retracting and deploying in unison with the second mechanism for retracting and deploying to deploy the first flexible sheet of fabric and the second flexible sheet of fabric, as the first flexible sheet of fabric and the second flexible sheet of fabric deploy, the zipper teeth are automatically engaged with the mating zipper teeth by the fastener.

8. The method of claim 8, further comprising the step of:
operating the first mechanism for retracting and deploying in unison with the second mechanism for retracting and deploying to retract the first flexible sheet of fabric and the second flexible sheet of fabric, as the first flexible sheet of fabric and the second flexible sheet of fabric retract, the zipper teeth are automatically disengaged with the mating zipper teeth by the fastener.

9. The method of claim 7, wherein the first flexible sheet of fabric further comprising a first weighted member disposed along a bottom edge of the first flexible sheet of fabric and the second flexible sheet of fabric further comprising a second weighted member disposed along a bottom edge of the second flexible sheet of fabric.

10. The method of claim 9, wherein the step of deploying is complete when at least one of the first weighted member and the second weighted member contacts a floor.

11. The method of claim 9, wherein the first mechanism for retracting and deploying includes a first roller mechanism and the second mechanism for retracting and deploying includes a second roller mechanism.

12. The method of claim 9, wherein the first flexible sheet of fabric is widthwise at an angle with respect to the second flexible sheet of fabric, wherein the angle is other than zero degrees and 180 degrees.

13. The method of claim 12, wherein the angle is 90 degrees.

14. The method of claim 12, wherein the first mechanism for retracting and deploying the first flexible sheet of fabric is affixed to a first support surface and the second mechanism for retracting and deploying the second flexible sheet of fabric is affixed to a second support surface and the fastener is held is a substantially static position between the first support surface and the second support surface.

15. A multi-section screen system comprising:
a first flexible sheet having zipper teeth disposed along a side edge of the first flexible sheet;
a second flexible sheet having mating zipper teeth disposed along a side edge of the second flexible sheet;
a first roller mechanism interfaced to a first surface, a top edge of the first flexible sheet interfaced to the first roller mechanism such that turning of the first roller mechanism in a first direction results in winding of the first flexible sheet around the first roller mechanism and turning of the first roller mechanism in an opposing second direction results in unwinding of the first flexible sheet from around the first roller mechanism;
a second roller mechanism interfaced to a second surface, a top edge of the second flexible sheet interfaced to the second roller mechanism such that turning of the second roller mechanism in the first direction results in winding of the second flexible sheet around the second roller mechanism and turning of the second roller mechanism in the opposing second direction results in unwinding of the second flexible sheet from around the second roller mechanism; and
a fastener, one side of the fastener slideably interfaced to the zipper teeth and a second side of the fastener slideably interfaced to mating zipper teeth whereas the fastener automatically joins the zipper teeth with the mating zipper teeth as the first roller mechanism and the second roller mechanism turns in the first direction thereby deploying and joining the flexible sheets, and the fastener automatically disengages the zipper teeth from the mating zipper teeth as the first roller mechanism and the second roller mechanism turns in the second opposing direction, retracting and separating the flexible sheets.

16. The multi-section screen system of claim 15, further comprising a first weighted member affixed to a bottom edge of the first flexible sheet and a second weighted member affixed to a bottom edge of the second flexible sheet.

17. The multi-section screen system of claim 15, wherein the first roller mechanism and second roller mechanism are driven by a single motor, the motor turning each of the first roller mechanism and second roller mechanism at an equal rate of revolution.

18. The multi-section screen system of claim 15, wherein the first roller mechanism and second roller mechanism include fins to provide an air gap beneath the first flexible sheet and second flexible sheet while the first flexible sheet and second flexible sheet are retracted around the fins.

19. The multi-section screen system of claim 15, wherein the first surface is at a widthwise angle with respect to the second surface and the angle is other than zero degrees or 180 degrees.

20. The multi-section screen system of claim 19, wherein the angle is 90 degrees.
